(19) United States
(12) Patent Application Publication
(10) Pub. No.: US 2015/0300539 A1
(43) Pub. Date: Oct. 22, 2015

(54) INVENTIVE SYSTEM AND METHODS FOR MAKING COMPOSITE REINFORCED PIPE BY ECCENTRIC APPLICATION WITH THE PORTABLE AND MOVABLE FACTORY, AND INSTALLING THE PIPE IN A PIPELINE

(71) Applicant: SMART PIPE COMPANY, INC., KATY, TX (US)

(72) Inventors: KENNETH R. CHARBONEAU, SLIDELL, LA (US); ARON R. EKELUND, KATY, TX (US); GARY LITTLESTAR, KATY, TX (US); IVAN C. MANDICH, NEW ORLEANS, LA (US); STEPHEN C. CATHA, KATY, TX (US); JUSTIN M. REED, KATY, TX (US)

(21) Appl. No.: 14/692,241

(22) Filed: Apr. 21, 2015

Related U.S. Application Data
(60) Provisional application No. 61/982,137, filed on Apr. 21, 2014.

(51) Int. Cl. F16L 11/16; F16L 11/08; B32B 38/00; B32B 38/18; B32B 37/20; B32B 38/08

(52) U.S. Cl. CPC F16L 11/16; B32B 37/20; B32B 38/08; B32B 38/0012; B32B 38/18; F16L 11/081; B32B 2597/00

(57) ABSTRACT

A transportable system and method for the in situ eccentric manufacturing of reinforced thermoplastic pipelines in continuous lengths up to 10 miles and from 8 to 60 inches in diameter having a rotating frame assembly with a eccentric spools for application of reinforcing tapes and other components to a polyolefin core pipe, and further having a forming machine for cross sectional shape reduction of the reinforced thermoplastic pipelines to facilitate pulling the reinforced thermoplastic pipelines inside a host pipeline. Also provided are continuous monitoring and marking with application of tape in the hoop stress direction and the axial stress direction as well as saturated tape feeding stations for impregnation of the reinforcing tape for in situ curing.

This application claims priority from U.S. Provisional Application No. 61/982,137 (the '137 application), filed Apr. 21, 2014. The '137 application is incorporated herein by reference.

### BACKGROUND

The invention relates to a method and structural inventive system-construction or mechanism for the eccentric method of manufacturing reinforced thermoplastic (RTP) pipelines and conduits, utilizing a composite structure and instrumented with inventive detection systems and sensor systems. Historically, in situ manufacturing (manufacturing on-site) of large size RTP pipelines and conduits was not previously available for transportation to a site because of the limitations imposed by the transportation and equipment sizes, and specifically indicated herein is the inventive means of manufacturing long lengths, up to 10 miles, for continuous installations either in pipelines or a standalone product which has not been available to date. The history of the eccentric method of the manufacturing and field installation with the use of the transportation flexibility of inventive machines, until today, was not provided for the pipe and conduits made ready for the transportation and installation in large sizes up to 60 inches in diameter. All other high pressure RTP piping systems are non movable factory based, made in short lengths for transport, not site portable and are limited in sizes with their production methods with the inventive RTP products and in-situ production methods specified here. This novel method of eccentric manufacturing of the pipes and conduits considers the primary forms of the large size RTP pipelines and conduits that can be shape formed in a reduced cross sectional shapes, such as “C” and “W” forms among others, which are considered the two most structurally effective cross sections in terms of the stress distribution and the practical applicability for the preservation of the integrity of the RTP pipelines and conduits (herein referred to as Smart pipe) in its installation and function. The formed shape of the Smart pipe mitigates rotational torsion due to the cross-sectional reduction of the full outer diameter. Formed shapes generally reduce full outside diameter by up to 50%.

The formed shape of the Smart pipe reduces pulling forces during installations, by allowing for uniform stress distribution within the formed shape, and by reducing surface areas that are in contact with the host pipe wall therefore reducing frictional force required for pulling. This enables the use of Smart Pipe for long continuous installations into the host pipe or host conduit, or as a free standing pipe in a trench or along any other surfaces either on land or in water.

The inventive eccentric manufacturing system provides for compact machinery systems where the “cage” or the frame like structure contains eccentric spools, that by rotation of the overall system, applies the reinforcing tapes, tows and other components to the polyolefin core pipe, as per desired design, under tensions in helical and contra helical configuration, and utilizes instrumentation for control and monitoring of such Smart pipe manufacturing during the process.

Continuous monitoring equipment and or cables are applied during the manufacturing process or during installation process or during inspection processes after installation. Continuous marking or labeling is applied during the manufacturing process or during installation process by means of print labeling, graphanine labeling or marking, or any other electronic labeling system. The labeling or marking systems can be used in comparative analysis as each measurement of length and/or diameter is relative to the time of the inspection and recorded as data and stored within the labeling or marking system within the Smart pipe for future inspections.

The Smart pipe manufacturing data and pipe properties can be monitored and measured, through the manufacturing phase, transportation phase and/or storage phase and subsequent installation at the site.

The stated method of eccentric large size Smart pipe manufacturing has a unique benefit in the onsite manufacturing provision and delivery of the finished product directly suited for a site simultaneous installation. This inventive system is also inclusive of the prior art from the same family of inventions related to the RTP composite reinforced pipe systems with the application of the high strength materials suitable for moderate to very high internal operating pressures, and also including new high strength materials derived for the use of carbon nano materials and/or graphanine materials.

The novelty of the system also includes the impregnation method applied to the strength tapes in their helical and contra helical means of construction over the core pipe. This has to be recognized as a method by which the large size pipelines, if of the standard weight, would be impossible to install in a long distance continuous pulls due to the excessive friction as a result of the weight, and an excessive wall thickness of the core pipe. The large size pipes also are preferred with an added rigidity in the pipeline construction. This rigidity is accomplished with the novel method of the impregnation or saturation of the high strength tapes, which are already used in the original design for the high pressure, long distance pull, of the pipes. The novelty includes the formation of such a rigid system to be a part of the reduced shape of the cross section of the pipe, and as such capable to be provided into the host pipelines, and to be cured as installed, and finally accomplishing a rigid pipe formed inside a pipeline, casing, conduit or a free standing pipe. This method of a light high strength large pipes pulled and installed, and in situ cured of the impregnated layers, is a novel method for forming a pipe of a rigid composite pipelines. This has not been available in the industry until today. The manufacturing system, as presented is partially amended with the equipment for the pipe saturation consisting of extra baths and refrigeration, sleeves, closely positioned near the taping equipment. The application of the saturated tape materials is immediately done before the tapes are positioned on the core pipe.

The novelty of the system and method also includes the manufacturing of the pipe in the mode of the two types of the tape application where the hoop stress taping and the axial stress tapes can be done with the same or separate machines adjoining the already established manufacturing equipment. This has to be recognized as the only specific dual method, exclusive to the eccentric machines, the eccentric methodology being the only suitable arrangements for such a production.

The novelty includes the formation of such a dual component system and method where the most variable stress conditions in the pipeline can be accommodated. The application can be applied in the plurality of the layers as per a desirable design. The use of such pipeline is suitable for the sea risers and other special conditions of the pipelines, requiring a high stress service, including the pipelines and conduits under such conditions in general industrial applications. All these will benefit from the type of the dual stress combination pipes. Presently there are combinations of the steel and polyolefin pipes available but not the light type non-metallic pipes as it is the subject of this invention.

The known state of the art, which is in the existing manufacturing, is partially here amended with the new equipment capable of the hoop stress application of the high strength tapes. These added components consist of the extra parts incorporated within the eccentric machinery, in a close proximity to the taping equipment, or can be used in a separate configuration with the equipment being attached to the taping machinery. The applied dual system of the stress respondent is for all purposes suitable for the RTP pipes, cured RTP pipes, which are the part of this patent, all being reduced in cross section and/or fully configured rounded pipes up to 60 inches in diameter. This modification to the existing equipment, by adding the components can be considered the innovation belonging to the family of the RTP production lines so far presented in other patents.

### SUMMARY OF THE INVENTION

The inventive system and methods for large size Smart pipe manufacturing by the method of eccentric application of composite materials applied over long lengths by means of in situ production is a novel method and apparatus which is presently non-existent in the pipeline industry, where the equipment for manufacturing can be transported, and facilitated for a continuous form of different shapes manufacturing, offering the most efficient way of continuous production of the Smart pipe systems, and continuous inspection from manufacturing, through the transportation and installation.

It is an object of this invention to provide an apparatus and method for the eccentric manufacturing of long length Smart pipes in large sizes from 8 inch to 60 inches in diameter, including all in between, and allowing for up to 10 miles assembly of the Smart pipes in a continuous form. The apparatus and method is claimed to be the invention in its entirety of use for manufacturing and transportation to the installation site where there is predesigned layout of the factory specific to the site requirement for the production of the Smart pipe product of a specific strength and capacity in use. Where the dual application of hoop and axial stress modes are used, the pipe sizes considered will be from 4 inch to 60 inches in diameter.

The modes of the transportation of the equipment to site include any possible available transportation method including but not limited to vehicular truck transportation, rail cars transportation, water transportation and air lifting type of transportation. Such manufacturing system is specifically designed to be suitable for any specified mode of transportations. The assembly and re-assembly of the manufacturing components are the part of the design and novelty of this invention.

The inventive system and method is also capable of providing additional tape or spooling heads, meaning more than two, which may be used in the process of the onsite manufacturing whereby the factory can produce long sections of Smart pipe by using additional tape or spooling heads and/or continuous reloading of spooling heads. In such designed configuration the tape or spooling heads can be of different sizes and configurations that allow for tilting the coils on the rotating frame and is applied as the eccentric manufacturing process demands.

The inventive system and method also provides for the tandem assembly of the manufacturing equipment which would render a multiple application of the reinforcing material on the Smart pipe product to meet high strength requirements with a significant safety margin. The inventive system and method also provides for the added components in the assembly of the manufacturing equipment which would render a dual stress application of the reinforcing material on the Smart pipe product to meet even more specific hoop and axial high strength requirements.

The Smart pipe can be used as a double safety provision (double barrier) for a planned replacement or planned installation of a pipeline as would be required by customers. Presently there is no such Smart pipe or conduit system available on the market. This inventive system provides for a full length Smart pipe for a planned installation or/and insertion into an existing host pipeline or conduit or as a stand-alone system.

The technical features of this inventive system and method provide for a compact and transportable equipment for manufacturing at the site for a long Smart pipe continuous production, in such a way that it will dramatically reduce the installation cross section, which are formed sections, by allowing for uniform stress distribution within the formed shape, and by reducing surface areas that are in contact with the host pipe wall therefore reducing frictional force required for pulling. In its new geometry the reductions which in part are the novelty of the invention whereby the redistribution of the weight of the pipe and its compactness, when compared to the full cross section, is showing one technical nature of the pipe in a developed stage and the other compact nature of the pipe in the installation stage, for the benefit of the elegance of this technology in its application.

The inventive system uses a calculated method for the composite layers application, other instrumentation added to the Smart pipe, multiple layers for strength application, interchangeable components and how those are managed in the production, the eccentric movement of the equipment and versatility of the equipment in use, versatility of the pipe in motion or equipment in motion, the sophisticated ergonomic systems in production, a total control over the production line in synchronization, and other features of smart elements composing within the same manufacturing process.

The organization and mobilization and demobilization of such systems and the production phase are all environmentally friendly processes with a minimal footprint in any environment. The supply and extraneous elements of the production are also part of the organization of the site manufacturing, and as such the entire operation is suitable for a relatively small footprint which minimizes on site operating time. The manufacturing process allows for start and stop operations including accumulation systems which compensates for non operating time during a manufacturing run. The operation of the reloading of the system is also possible during such stand by time, or otherwise it is a continuous flexible replacement operation related to the flexibility of the equipment where the production line at the minimum speed of movement allows such reloading.

The second most important feature of this inventive system is in the provision whereby the large size of the Smart pipes are reduced to the smaller handling sizes, thereby allowing for the coiling, storage and accumulation of the pipe for later installation, but are not limited as is the case with the smaller sizes of the pipes presently in practice in this industry. Without such method of reductions the length of the Smart pipe would be limited due to the large dimension of the product to a sectional manufactured product cut to a short transportable sections. Such novelty of on-site manufacturing and installation, or storage in preparation for installation has not been practiced before in the pipeline industry with the large diameter products i.e.: greater than 6 inch diameter.

The inventive system for eccentric in situ manufacturing of the long large size Smart pipes follow with the description and inclusion of the drawings and noted items or the components for better understanding of this “first-to-file” document designated as the figures from 1 through 17.

It is an object of this invention to provide an apparatus for the eccentric manufacturing by the portable and transportable machinery necessary for the large sizes of the long length Smart pipes with such equipment's flexibility in transportation by various modes to a manufacturing “in situ” location, and to provide a product in variety of the reduced cross sections, primarily the two technically advanced “C’ and “W”, but not to the exclusion of other shapes, which facilitates the redistribution of the stress, and allowing for up to 10 miles assembly of the Smart pipes in a continuous form. The mechanism that is claimed to be the invention, in its entirety, is used for manufacturing and transportation to the installation site and/or for storage at installation site.

It is further intended to apply the inventive method and apparatus to various modes of transportation, by means of the vehicular truck transportation, rail cars transportation, water transportation and air lifting type of transportation.

It is further intended to provide the means of providing long Smart pipe systems for replacement, emergency replacement and new installations, and for storage of the Smart pipe for the purpose of later installations, or emergency replacement installation.

It is further intended that the novel use of this inventive system also will have sensors to monitor stresses, strains, temperature, and identify leaks, and identify chemical analysis, and identify movement of the pipe during loading of the pipe, transportation and/or storage of the pipe for round pipe and shape reduced cross sections of the Smart pipes, as well as monitor the same after installation along with continuous monitoring as well as capability for periodic testing based on these parameters.

The type of sensors envisioned for monitoring as above can include: piezoelectric sensors, transducers, radio frequency sensors, graphinine sensors, nano material sensing systems and conductivity sensing.

It is further intended that proprietary computer hardware and software is also a part of the inventive system and it is used in the theoretical modeling as well as in the monitoring as well as periodic inspection by means of sensors as applied to the systems.

It is further intended that proprietary manufacturing and installation processes are environmentally safe operations, with no hazards, no toxic materials and uses non flammable products.

It is further intended that the novel method of the invention is in its method of compactness for transportation and location “foot print” of the portable system which can be operated as a portable and also as a transportable factory, as compared to current industry technology utilizing stationary, non transportable equipment.

It is further intended that the novel method of the invention will also be utilized as a movable transportable factory whereby the operation can be conducted not only in a new set-up position as a portable factory but also that the entire factory can move simultaneously along the along a pipeline, a conduit and/or a right-of-way.

It is further intended that the novel method of the invention will also be capable of manufacturing the Smart pipe with the overlays and tapes in their saturation state and that will provide a rigid pipe, upon the in situ curing, and the pipe will have increased solid wall thickness upon the curing of the impregnated layers.

Such pipe method will not require increase in the core pipe thickness (usually HDPE solid wall material), and for that reason it will be considered a light type high strength pipeline suitable for a long distance installations.

It is further intended that the novel method of the invention will be capable of manufacturing the Smart pipe with the dual system of overlays and tapes for the acceptance of the hoop and axial stresses in all possible configurations and plurality of the applications, and that it will provide a responsive pipe for use in the sea application and other special strength applications.

Such pipe method will not require use of the hoop stress metallic carcass component, and it will be considered a light type pipeline suitable for long distance installations.

### NOVELTIES OF THE INVENTION AND INNOVATION

A. The present manufacturing process for continuous Smart pipes has no provision for the continuous long length Smart pipe's in situ manufacturing, with the eccentric type of manufacturing equipment which satisfies the condition of mobility and transportability to the site as well as the site assembly's portability. The most important thing to note in this novelty of invention is that the size of the smart pipe product is considered totally new in such a production method. The reference is here to note that such prior art exists in the manufacturing, and installation of composite products such as “Smart Pipe” where the employment of a different methodology in manufacturing is considered to be of the concentric type, rather than the eccentric type in this novel invention, and as such it is developed with machines already patented as a prior art. The inventive system is for the RTP reinforced thermoplastic composite Smart pipes and conduits. This novel method for the manufacturing of the long lengths of Smart pipes is the logical progression of the assemblies necessary to accommodate various sizes of the Smart pipes and it represents an addition to the family of the inventions pertinent to a body of the inventions for the products with the generic name known to be “Smart Pipe” (trade name) available in today's market.

B. The novelty of this inventive system is that the factory assembly is arranged in such a way that the field production can be accomplished where the order of the machines is predicated on the design for a particular size and the strength of the product. Included in this consideration is also a type of the transportation mode, such as containers, barges, flotillas, and other means of transportation that can move and remobilized the factory at any site location.

C. The novelty of the system is in its expansion from the two spool heads to more which is done by means of the same type of the equipment, namely the one capable of the eccentric machine production and suitably compact so that the large size Smart pipes are in a relatively tightly positioned equipment around the pipe.

The inventive system's versatility allows for the sizes up to 60 inches to be processed and furnished as fully structural Smart pipe. The possibility of the sizes up to 60 inches in diameter are also considered in this invention by means of dismountable parts that can be shipped as separate components and assembled at the site, whereas the assembled arrangements or equipment would surpass the height and allowable transportation parameters and sizes.

D. The novelty of this inventive system is in its advantage where the new large size Smart pipes, made of the composite multi layered high strength, light weight, durable materials are by the ways of the reduction in the sizes of their cross section brought to the manageable installation and transportation and in small compact sizes, easy to be handled, when compared to rigid and solid circular types of pipe systems which for these technical reasons are not suitable for such handling.

E. The novelty of the invention is in its mechanics of the methods for making the pipe which is in essence a small wall thickness and made from the applied layers in helical and contra helical direction, for which there is no demand for a substantial increase in all production machinery for variety of sizes, this being varied only by the types and layers but not substantially by the added thickness of the pipe, the wall thickness being usually a cause for retooling of the machines, which is not necessary in this novel invention. As such the large size pipes are fitted within the system of this novel production with minimum variability to be done to the equipment's passages for the pipe, no need for framing modifications, and no need to site reconfiguration that would require a totally new production line.

F. The novelty of the invention is in its mechanics of the methods for making the pipe with a small wall thickness core pipe (HDPE) and made from the applied layers in helical and contra helical direction, with the applied saturation of the material to be later cured at the installed pipe stage. The novelty of the invention is that the saturation and applied tapes are provided as a system which is formed in “C”, “W” or other shapes in the saturated state, and that the pipeline is installed and then cured after its conformance to the host pipe, conduit or the free state of installation.

G. The novelty of the invention is in the mechanics of the methods for making the pipe with a plurality of the taped layers in such a configuration which will provide the hoop stress and axial stress structural components on the core pipe (HDPE) and which will be made from the applied layers in helical and contra helical direction, and the hoop layers in circumferential direction. The novelty of the invention is that such diversity in stress application is specific to the eccentric equipment.

### BACKGROUND OF THE INVENTION AND INNOVATION

The invention relates to plastic and reinforced thermoplastic composite Smart pipes and conduits of the sizes up to 60 inches in diameter. The invention is the first of its kind using an eccentric production method in such application for long Smart pipes that provides for a full continuous production for the entire length for the most commercially installed pipelines.

This technology is made available in conjunction with the prior art for making the composite Smart pipes and represents inclusively patented body of the inventions within the family of the products named RTP reinforced thermoplastic pipes.

This technology, as it relates to the composite Smart pipes, is capable of accommodating primarily the “C” and “W” formed sections as the most technically advanced features of the product, as well as other patented cross sections, as we can name them here to be as “form shaped sections”, and specifically noted in the “Smart Pipe” patents.

This technology, as it relates to the composite Smart pipes, is capable of accommodating saturated helical and contra helical tapes on the core pipe for further processing, and finally constructing the RTP pipe with the solid walls of the core pipe plus the high strength solidified pipe, hence increasing the rigid structure with such double solid walls.

This technology, as it relates to the composite Smart pipes, is capable of accommodating helical and contra helical tapes, as well as hoop stress plurality of tapes, on the core pipe for constructing the RTP pipe with the exceptionally high strength capacity and long pulling lengths, hence, hence, providing the application of the RTP pipe in specialty uses.

The eccentric manufacturing capacity is the function of the sizes, length of the material on the spools, width of the fabric material, number of layers in application, the re-loading of the spools, mechanics of stopping or not stopping during the re-loading operation, the speed and application of the structural angle over the pipe, and other auxiliary functions which are all coordinated and interfaced by a novel method of the process controls.

This inventive system is substantially different from the small size production of RTP pipes and in its characterization of such produced geometry in size and diameter and suitability for storage of large amounts in continuous lengths. The unique production and geometry is of a different technical nature and cannot be done by the same means and methods that are available for the production of small diameter RTP continuous pipes.

The eccentric manufacturing process is solely adaptable for the hoop and axial stress combinations, whereby, the same equipment for the helical and contra helical use is augmented for such method of the manufacturing.

### BRIEF DESCRIPTION OF THE DRAWINGS

FIG. 1 shows the front entry, and side elevations showing the positions of the eccentric use of the frame assembly.

FIG. 2 shows a rotating position of the frame assembly from the front view of the operation and from an exit elevation.

FIG. 3 is a depiction of the assembled eccentric equipment showing the front, side and back views.

FIG. 4 is a depiction of the cross sections in comparison of the sizes showing how the same size of the round pipe is reduced in its cross section.

FIG. 5 is the typical composite Smart pipe's isometric detail.

FIG. 6 is showing a typical cross section of the “shape formed” Smart pipe which is the primary product of this invention.

FIG. 7 is the isometric view of the two eccentric machines operating in tandem whereby a process of the doubling of the tape application is shown. For more applications there are the other possibilities, not shown on this drawing, whereby more spools are added or more units are in a simultaneous operation.

FIG. 7a shows the left eccentric machine depicted in FIG. 7.

FIG. 7b shows the right eccentric machine depicted in FIG. 7 working in tandem with the eccentric machine of FIG. 7a.

FIG. 8 is the plan of the two eccentric machines in operation while travelling over the rails.

FIG. 9 is the plan showing of the total factory in its one configuration showing the line of the equipment necessary for a production in situ. The arrangement of the equipment is a novelty of this invention since there are the features in such composition of the equipment necessary for accomplishing the work of the eccentric equipment, shape reduction equipment, pulling and control monitoring of the production.

FIG. 10 is the plan and front view showing multiple heads of the eccentric equipment which represent an alternative production for the Smart pipe where more layers would be applied in the process of making the pipe.

FIG. 11 is the plan view showing a saturation components of the eccentric equipment and helical and contra helical application of the saturated tapes ready to be installed over the core pipe.

FIG. 12 is the isometric view showing saturation components as an assembly on the core pipe.

FIG. 13 is the cross section and the list of the saturation components in the assembly on the core pipe in the reduced cross section of “C” shape but also applicable to “W” and other shapes.

FIG. 14 is the cross section showing saturation components as an assembly on the core pipe in the finished cured and rigid type assembly as one pipe.

FIG. 15 is the plan and the view showing augmented components to the helical and counter helical equipment, in a tandem assembly, where the horizontal head movements and the diverting arms are arranged for the application for the hoop stress tapes.

FIG. 16 is the plan showing augmented components to the helical and counter helical equipment, within the same assembly, where the horizontal head movements and the diverting arms are arranged for the application for the hoop stress tapes.

FIG. 17 is the isometric display of the pipe components and the list of the parts in the assembly on the core pipe.

### DETAILED DESCRIPTION OF THE INVENTION

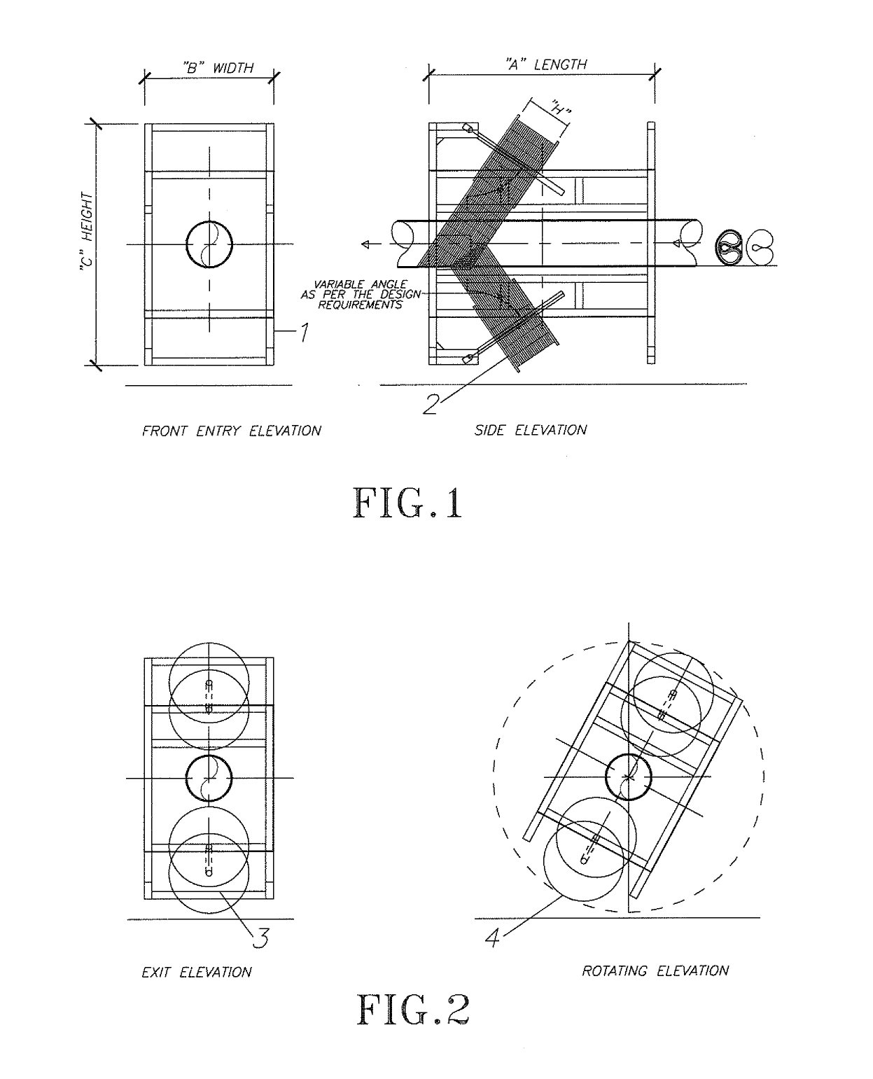

FIG. 1 shows the front entry and side elevations showing the positions of the eccentric use of the frame assembly 1 but does not show the supports within which this frame assembly 1 is put in motion. Also shown are the positions of two spools 3 in application of helical and contra helical tapes 2 over the core pipe and also showing the superimposed cross sections of the same round pipe in its reduced form. The helical and contra helical application tapes 2 on the spools are shown with cantilevered arms positioned in relationship to the core pipe, equipped with a mechanism for rotating the eccentric “cage” the frame 1, and mounted with arms for loading and unloading of the tapes 3. The dimensions “A”, “B” and “C” are suitable dimensions for installation on flat bed trucks, barges and other means of the transportation. This frame assembly 1 was specifically designed to be portable with the two spools 3 and frame structure as compact one piece equipment. The addition of more spools 3, which are the part of this invention, are in the same context, changed in the assembly whereby the spool components, the frame and the frame supports are re-assembled for transportation purposes and at the site composed together where the space is allowing for such larger type of the equipment to be operated. The frame assembly 1 is suitable for the transport to a site ready for manufacturing of large size composite RTP Smart pipe by movable and/or stationary eccentric tapers which can be expanded to multiple tapers.

In FIG. 2 is shown a rotating position of the frame assembly 1 from the front view of the operation and from an exit elevation, describing the extent of the circular motion of the frame and from which is determined the maximum height of the assembly 1 for the purpose of the environmentally conditioned manufacturing by means of enclosures, or tenting, for the purpose of handling in reloading of the spools 3 unto the equipment, and generally for the purpose of providing the equipment's limitation size as related to the transportation needs. FIG. 2 shows only one size of pipe but the other features will accommodate pipe sizes up to 60 inches in diameter and with modifications of the same principal equipment up to 60 inches in diameter are accomplished within the system of eccentric manufacturing by adding more spools at the site within the same limitations suitable for the site production. FIG. 1 only shows two coils 3 but double and quadruple coils can be mounted. The possibility of unobstructed space is indicated by the circular pattern 4.

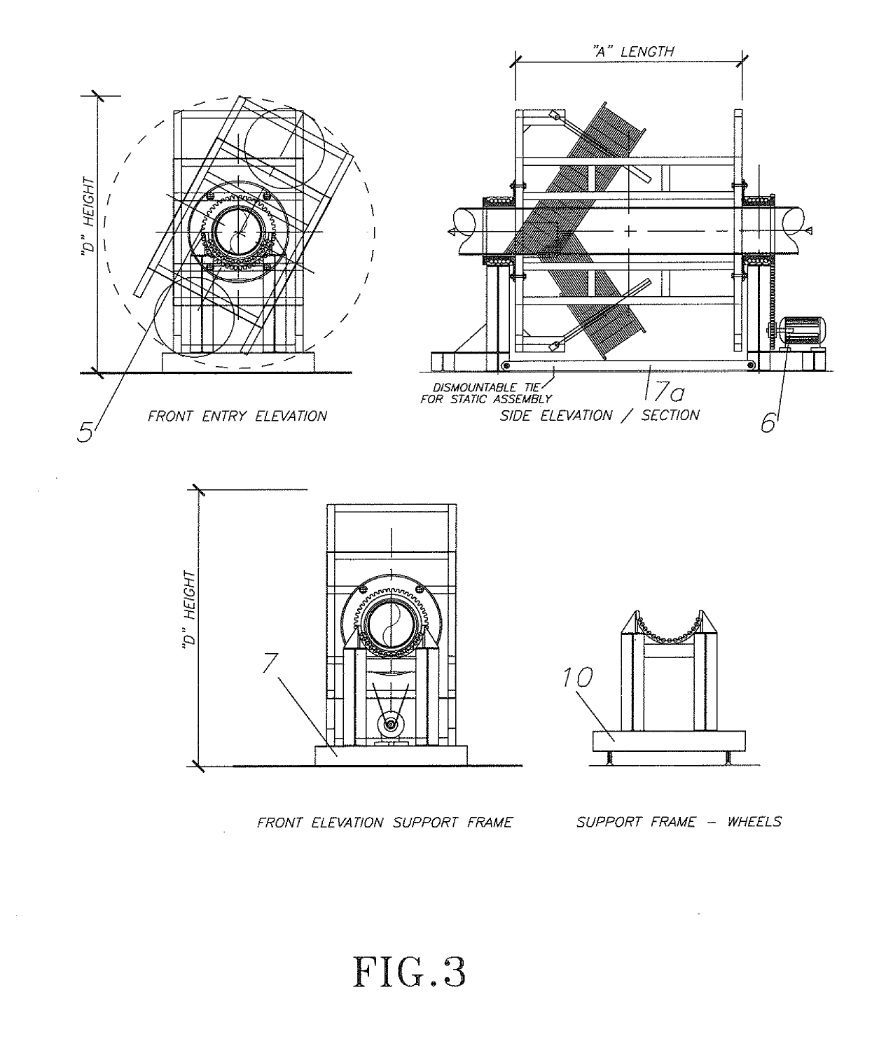

In FIG. 3 is a depiction of the assembled eccentric equipment showing front, side and back views, and indicating a driving mechanism 5 to rotate the eccentric cage-frame by controlled speed and power in coordination with the type of motion in manufacturing the RTP product where the operation is strictly controlled by the computerized programs proprietary to this application for the reinforced structural layers of the pipe. Shown are two side-attachable frames 7a upon which the rotating cage is resting on the roller type bearings, as those attachable frames are also the compact components transportable and assembled at the site. The general sizes as “A” and “D” are length and the height of the equipment in operation. Also depicted in FIG. 3 is a motorized driving mechanism 6 mounted on the support frames and providing torsional force for the eccentric frame rotation. The motorized driving mechanism 6 may be installed on both sides of the assembly as required for more power and torque. A support frame 10 with wheels is also shown.

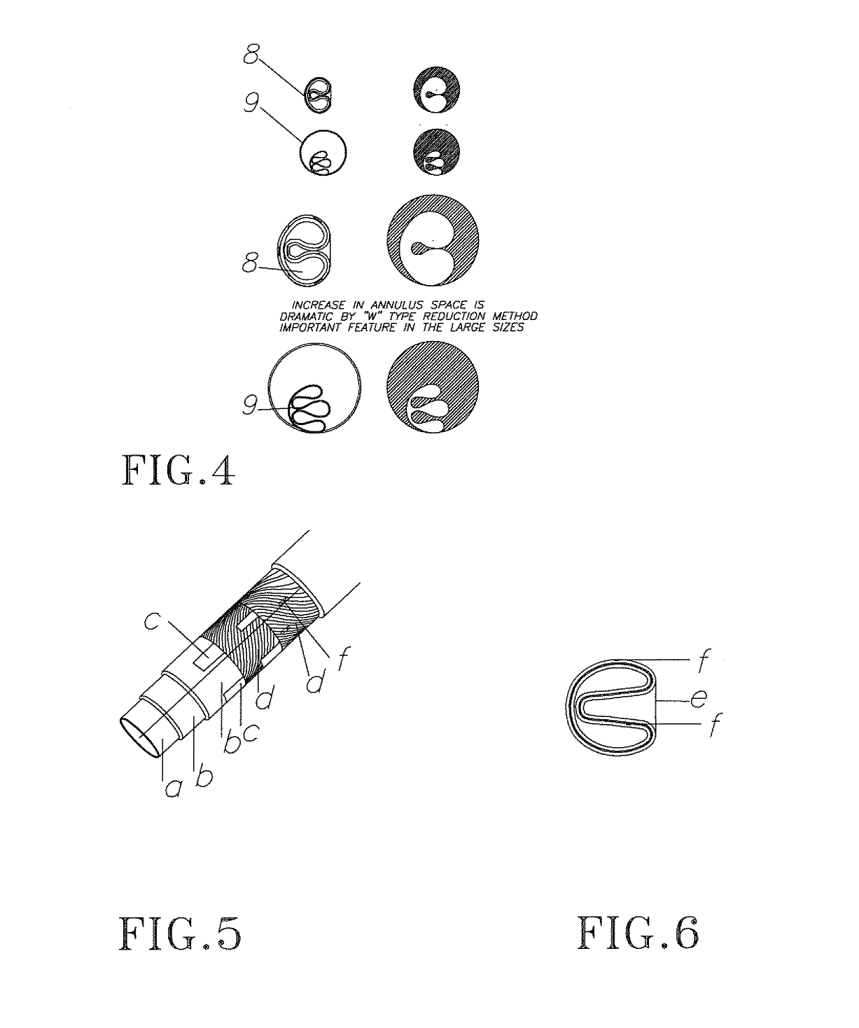

FIG. 4 shows a reduction of cross sections in composite pipes and is a comparison of cross sections of pipe sizes showing how the same size of the round pipe is reduced in its cross section and how these compact sections represent the two structurally suitable elements when subjected to the pulling forces in installation in long Smart pipes. This drawing depicts the standard formation of the shape “C” 8 and the shape “W” 9 in comparison, so that the benefit of their relationship to a large size pipes can be appreciated. The two technically advanced features of these cross sections are considered the most favorable, among others showing in the previous invention for the Smart Pipe, in light of the subject operation. As such this inventive system provides for the efficiency of the use of the large size diameters of the pipe and its conversion to manageable sections capable to be installed in the very long Smart pipes. This comparison is a technical part of this invention that provides the solution of the pulling the large size pipe inside a host pipeline or conduits or as stand-alone conducive for pulling in the process of the installation. This geometric feature is the inventive part of the handling of the large size pipes and their suitable conversion.

FIG. 5 shows an isometric view of high strength light type pressure pipe in one form of manufacturing practice for composite pipe types. Shown are the components of the Smart pipe construction including the monitoring inventive systems, pulling inventive systems, and all other features of such “smart pipe” designs including the novelty of monitoring the stored Smart pipes in all conditions. Additional sensors may be also used within the structure of the assembly such as at the frame structures used in manufacturing, and for the purpose of the application of the tapes under design tension. The components are depicted as follows:
a. Core pipe (polyolefin).
b. Wrapping layers helical and circular.
   Application in first and second orders as per the design for strength with embedded woven sensors within the fabric.
c. High strength pulling tapes with embedded woven fabric sensors.
d. Tows with embedded woven fabric sensors.
e. Covering assembly tapes, Mylar or other temporary security for the pipe shape forming and installation.
f. Sensors and readers for the various pipeline functions.

FIG. 6 shows the formation of the “C” shape reduction 8 of the pipe incorporating sensors, on or woven inside the fabric of the pipe, pulling tapes and strength added tapes. Other pipe shapes reduction is a prior art used in the manufacturing of composite pipes. The subject of the “W” shape reduction 9 is also considered similar to this “C” form presentation, but not shown in FIG. 6.

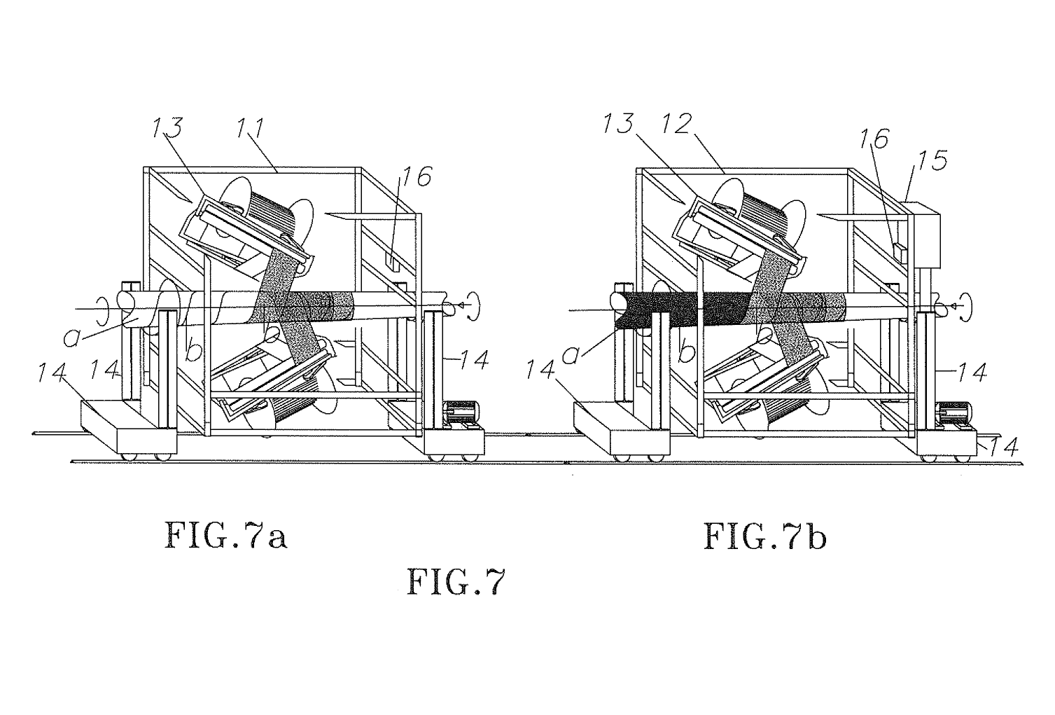

In FIGS. 7, 7a and 7b is depicted an isometric view of two eccentric machines operating in tandem whereby a process of the doubling of the tape application is shown. For more applications there are other possibilities, not shown on these drawings, whereby more spools are added or more units are in a simultaneous operation. There are three modes of operation:
1. Pipe turns in eccentric application by means of the machine moving over the pipe.
2. Pipe moves through; eccentric application by means of the machine in the static position.
3. Pipe is static; eccentric application by means of the machine in motion.

The machine 11 depicted in FIG. 7a indicates the tandem operation of the machines and application of the tapes over the core pipe in the first passage while the overlay of the second machine 12 depicted in FIG. 7b immediately follows the first machine 11 in strict coordination to meet the technical demands for tape application in terms of angle of repose and tension. The extended arms 13 holding the spools 3 of the tapes 2 are dismountable and flexible in adjustment so that they can provide for the calculated angles of repose in the tape applications and also for the exchange of the spools in a continuous process of the manufacturing. The dismountable assembly mechanism 14 can be either static or mobile as required and is suitably designed to be flexible in transportation and assembly at the site. Control stations 15 are mounted on the drive mechanism, providing for direct and remote control of the operations. Also shown is a control station 16 used for a direct guiding and alignment in the process of the production, which is also coordinated into the entire control operation.

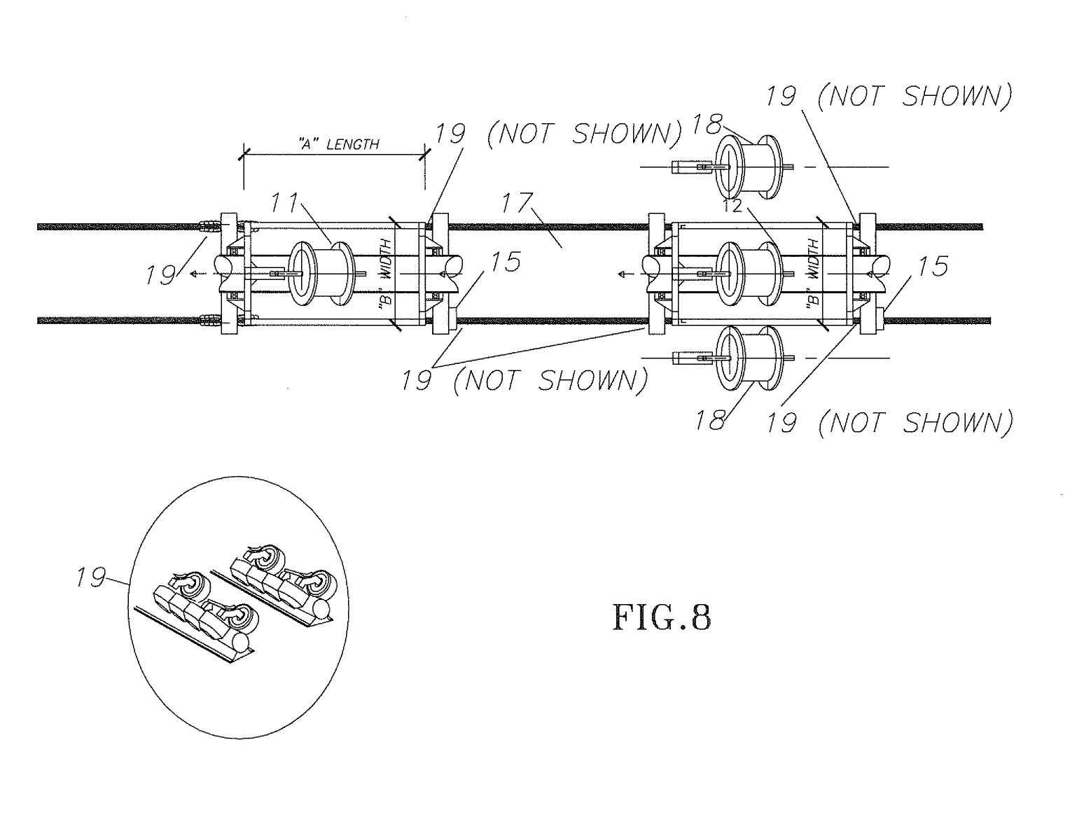

FIG. 8 shows a plan of the tandem operation 17 of two eccentric machines where helical and contra helical applications are repeated in overlays, where the number of overlays can be added as per the design for the strength and internal pressure is specified. Also diagrammatically indicated are two additional spools 18 that can be attached to the same frame assembly to multiply the application of the layers per each machine. These can be made active spools in simultaneous operation or they can be used as a replacement of the active spools when in need of the replacement. The detail shows the assembly of the wheels 19 which are provided for the movement of the equipment in such arrangement suitable for the most stable and the least friction resistant operation. This system of the driving wheels at the angled position towards the railings provides for a minimum friction and maximum stability of movement, and in turn the system provides for a steady control of the machinery in coordination during the manufacturing.

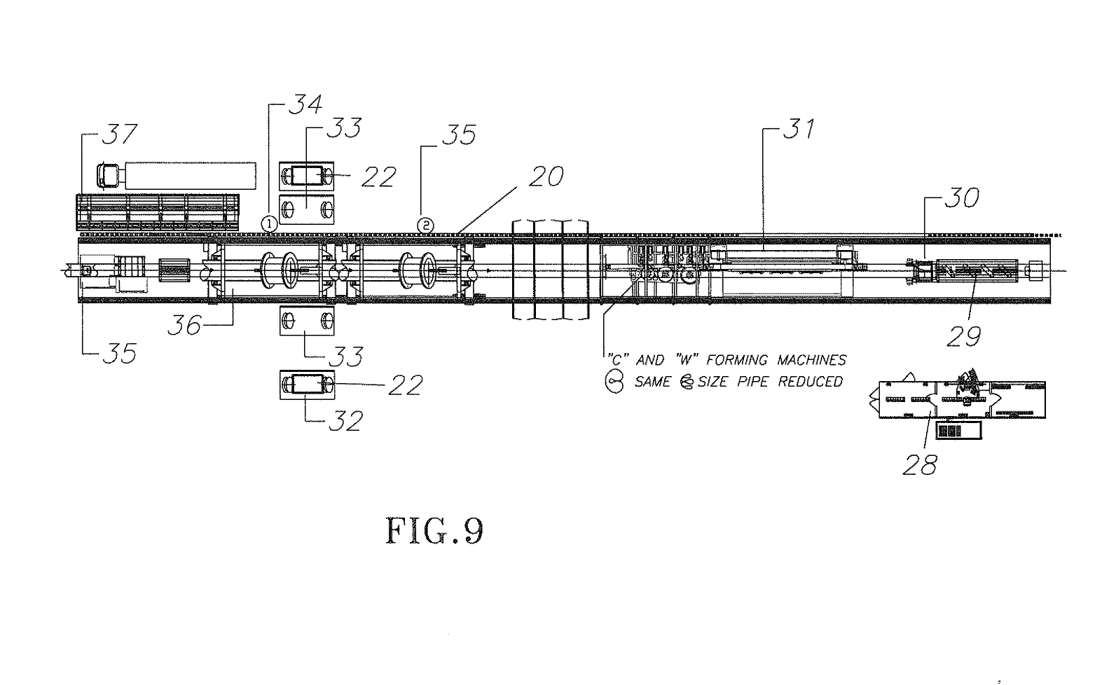

A plan of the assembly line 20 for a typical production of composite pipe using minimum equipment layout is shown in FIG. 9. This plan layout 20 provides one assembly of the entire operation necessary for the production of the composite pipe RTP. The novelty of the system is that it is site portable, it can operate under different weather conditions, it is self sustainable in the overall operation in terms of the power and logistics of the operation and it is environmentally friendly without any emissions and no discharges requiring any treatment or associated permits. The system operates with no hazardous or detrimental materials but with the product components all pre-made and pre-possessed for this type of the manufacturing.

As shown in FIG. 9, there is a prime mover caterpuller 36, a buffer caterpuller 31, a longitudinal wrapper 29, double eccentric Mylar taper 30, a counter helical tape head 35, a helical tape head 34, tape feeding stations 33, and saturated tape feeding stations 32. In connection with the tape feeding stations are containers 22 prepared for impregnation of the tapes which are in a continuous way applied on the core pipe. Also shown is a pipe rack and delivery 37, welding equipment 35 and a control station 28.

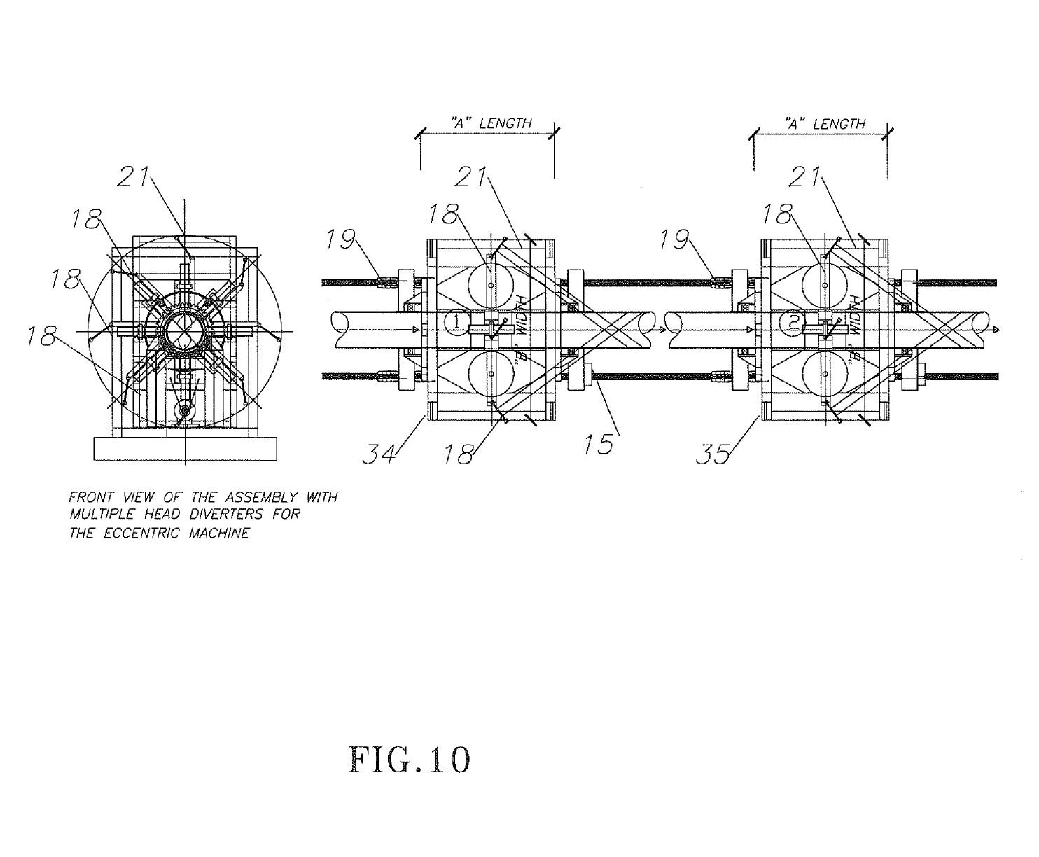

A plan and front view of the assembly line 21 with multiple head diverters for the eccentric machine is shown in FIG. 10. This represents an alternative production for the Smart pipe where more layers would be applied in the process of making the pipe. Such modifications are showing the packing of the spools, diagrammatically noted here, to indicate the same principle of this invention, namely, to be a large size eccentric application in making of the RTP composite products. The multiple eccentric systems where the equipment is under the operation of producing shorter sections can be used under the same principle of the eccentric manufacturing. The novelty of this system is also related to its portability in transportation by means of dismountable parts being used in the reduction of the height and width of the equipment needed to fit the transportation requirements to the site, and also the ergonomics at the site in assembling the entire equipment for production.

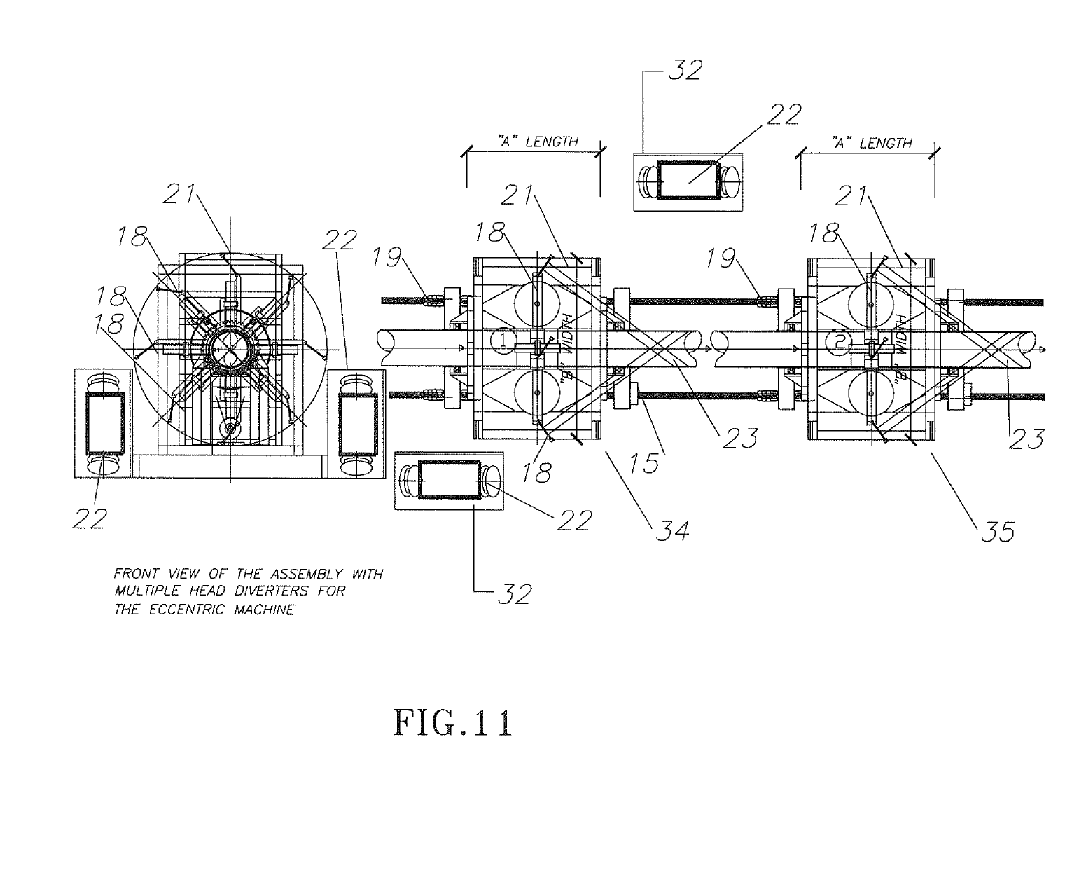

FIG. 11 shows a plan of the assembly line with the head diverters and the saturation Equipment. In FIG. 11 is shown saturated tape feeding stations 32, containers 22 prepared for impregnation of the tapes and the saturated tapes 23 applied on the core pipe in helical and contra helical motions.

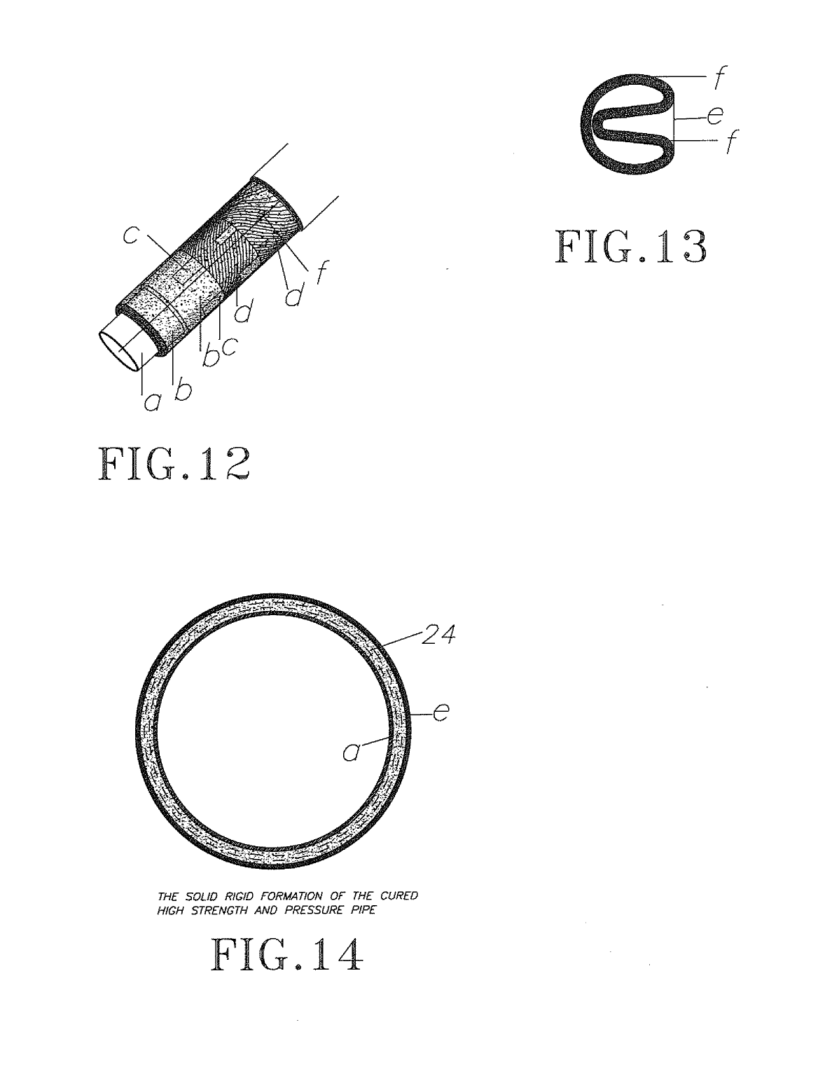

FIG. 12 shows an isometric view of the high strength light type pressure pipe composed of the solid wall thickness made by combined and impregnated and cured assembly.

FIG. 13 shows the formation of the “C” (“W”) shape reductions of the pipe incorporating sensors, on or woven inside the fabric of the pipe, pulling tapes and strength added tapes and forming assembly of the solid walls before curing of the saturated assembly. The components as depicted are:
a. Core pipe (polyolefin).
Items b, c, d, f represent one assembly cured in solid wall
b. Wrapping layers helical and circular.
   Application in first and second orders as per the design for strength with embedded woven sensors within the fabric.
c. High strength pulling tapes with embedded woven fabric sensors.
d. Tows with embedded woven fabric sensors.
e. Covering assembly tapes, Mylar or other temporary security for the pipe shape forming and installation.
f. Sensors and readers for the various pipeline functions.

In the cross section shown in FIG. 14, the saturated and cured assembly 24 is shown as applied on the core pipe in the installed stage.

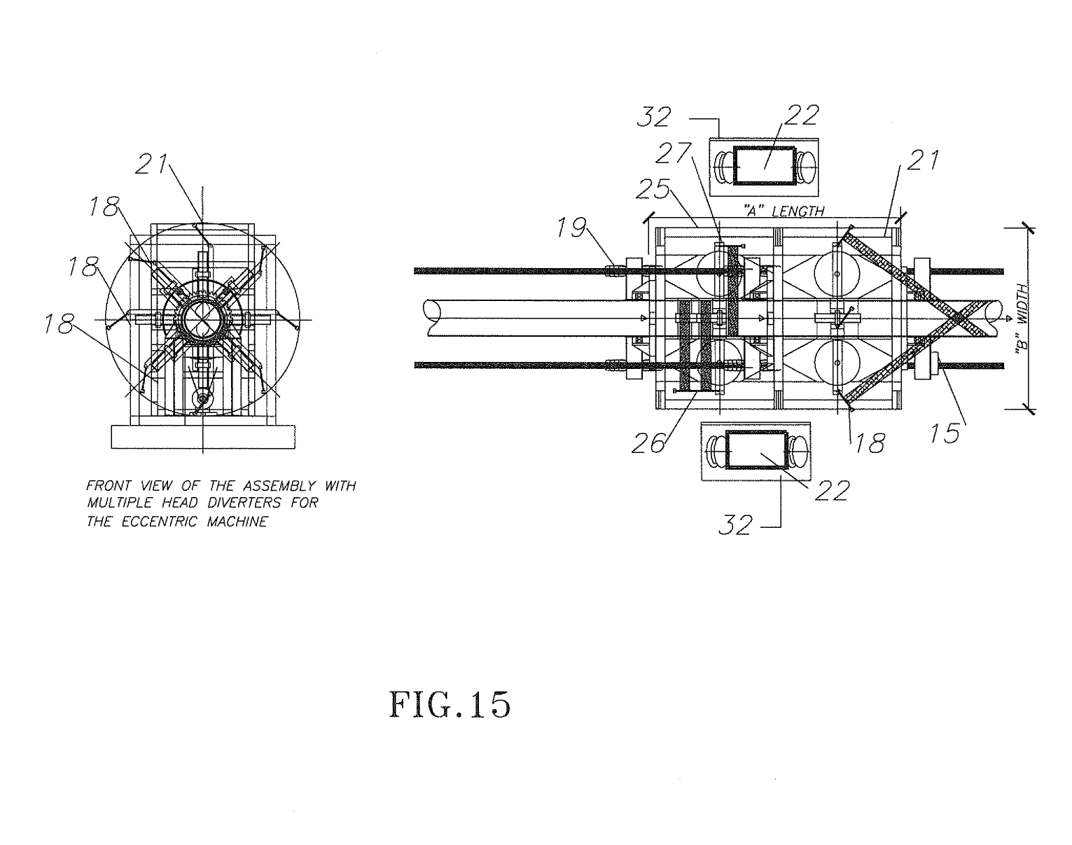

FIG. 15 shows a plan of the assembly line 25 with multiple head diverters for the eccentric machine for variable directional stress applications, from the hoop direction to axial configuration. This assembly line shows the variable installation 26 of the tapes by use of the application arms for the hoop stress configuration and the horizontal movement installation 27 of the application arms for the hoop stress configuration.

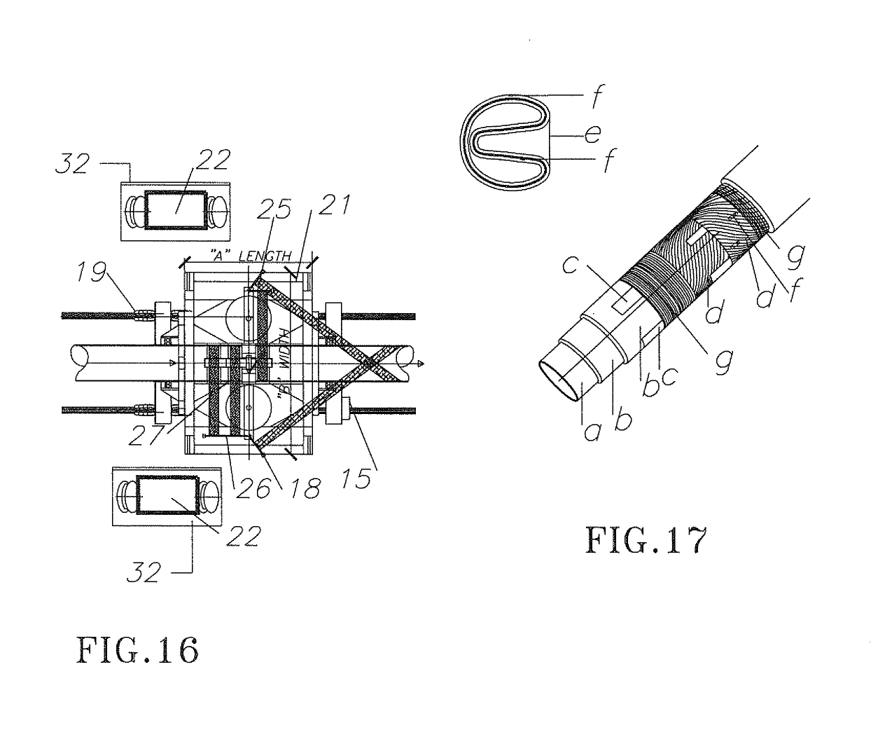

FIG. 16 shows a plan of the assembly line with multiple head diverters for the eccentric combined machine for variable directional stress applications, from the hoop direction to axial configuration.

FIG. 17 shows an isometric view of the high strength light type pressure pipe in one form of the manufacturing practice for the composite pipe types. Also shown if the formation of the “C” shape reduction of the pipe incorporating sensors, on or woven inside the fabric of the pipe, pulling tapes and strength added tapes depicting the hoop and axis modes of the composite pipes. The components as depicted are:
a. Core pipe (polyolefin).
b. Wrapping layers helical and circular.
   Application in first and second orders as per the design for strength with embedded woven sensors within the fabric.
c. High strength pulling tapes with embedded woven fabric sensors.
d. Tows with embedded woven fabric sensors.
e. Covering assembly tapes, Mylar or other temporary security for the pipe shape forming and installation.
f. Sensors and readers for the various pipeline functions.
g. wrapping layers in the hoop direction application in several applications as per the design for strength.

We claim:

1. A system transportable by truck, rail, water or air, for the in situ eccentric manufacturing of reinforced thermoplastic pipelines in continuous lengths up to 10 miles and from 8 to 60 inches in diameter comprising a first rotating frame assembly with a first and second eccentric spool for application of reinforcing tape to a polyolefin core pipe, and further comprising at least one forming machine for cross sectional shape reduction of the reinforced thermoplastic pipelines and conduits to facilitate pulling the reinforced thermoplastic pipelines inside a host pipeline.

2. The system of claim 1 wherein the shape reduction of the reinforced thermoplastic pipelines is a “C” shape.

3. The system of claim 1 wherein the shape reduction of the reinforced thermoplastic pipelines is a “W” shape.

4. The system of claim 1 wherein at least one additional rotational frame assembly is added to work in tandem with the first rotating frame assembly to increase the application of tape on the polyolefin core pipe.

5. The system of claim 1 wherein the eccentric spools are positioned in relation to the polyolefin core pipe such that the first spool applies tape in a helical direction and the second spool applies tape in a contra-helical direction.

6. The system of claim 1 wherein additional spools are provided for application of tape in the hoop stress direction and the axial stress direction.

7. The system of claim 4 wherein additional spools are provided for application of tape in the hoop stress direction and the axial stress direction.

8. The system of claim 1 wherein in addition to the application of reinforcing tape to the polyolefin core pipe, continuous monitoring equipment is added.

9. The system of claim 4 wherein in addition to the application of reinforcing tape to the polyolefin core pipe, continuous monitoring equipment is added.

10. The system of claim 1 wherein continuous marking is added during the manufacturing of reinforced thermoplastic pipelines.

11. The system of claim 4 wherein continuous marking is added during the manufacturing of reinforced thermoplastic pipelines.

12. The system of claim 1 wherein the system further comprises saturated tape feeding stations for impregnation of the reinforcing tape for in situ curing.

13. The system of claim 4 wherein the system further comprises saturated tape feeding stations for impregnation of the reinforcing tape for in situ curing.

14. A method for the in situ eccentric manufacturing of reinforced thermoplastic pipelines in continuous lengths up to 10 miles and from 8 to 60 inches in diameter comprising the steps of:
transport and assemble on site a manufacturing system comprising a first rotating frame assembly with a first and second eccentric spool for application of reinforcing tape to a polyolefin core pipe, and at least one forming machine for shape reduction of the reinforced thermoplastic pipelines;
move rotating frame assembly over the polyolefin core pipe with application of reinforcing tape from eccentric spools;
move polyolefin core pipe with applied reinforcing tape through forming machine to reduce cross sectional shape to a “C” shape;
move polyolefin core pipe with applied reinforcing tape in reduced cross sectional “C” shape to installation in a host pipe.

15. The method of claim 14 wherein the manufacturing system further comprises at least one additional rotational frame assembly to work in tandem with the first rotating frame assembly to increase the application of tape on the polyolefin core pipe.

16. The method of claim 14 wherein the polyolefin core pipe with applied reinforcing tape is moved through the forming machine to reduce cross sectional shape to a “W” shape.

17. The method of claim 14 comprising the additional steps of application of continuous monitoring equipment and continuous marking to the polyolefin core pipe.

18. The method of claim 14 comprising the additional step of application of tape to the polyolefin core pipe in the hoop stress direction and the axial stress direction.

19. The method of claim 14 comprising the additional step of impregnation of the reinforcing tape for in situ curing.

20. The method of claim 15 wherein the polyolefin core pipe with applied reinforcing tape is moved through the forming machine to reduce cross sectional shape to a “W” shape.

21. The method of claim 15 comprising the additional steps of application of continuous monitoring equipment and continuous marking to the polyolefin core pipe.

22. The method of claim 15 comprising the additional step of application of tape to the polyolefin core pipe in the hoop stress direction and the axial stress direction.

23. The method of claim 15 comprising the additional step of impregnation of the reinforcing tape for in situ curing.
